(19) United States
(12) Patent Application Publication
(10) Pub. No.: US 2016/0017194 A1
(43) Pub. Date: Jan. 21, 2016

(54) DOUBLE-SIDED PRESSURE-SENSITIVE ADHESIVE TAPE

(71) Applicant: NITTO DENKO CORPORATION, Ibaraki-shi, Osaka (JP)

(72) Inventors: Akiko Tanaka, Ibaraki-shi, Osaka (JP); Shigeki Ishiguro, Ibaraki-shi, Osaka (JP); Satomi Yoshie, Ibaraki-shi, Osaka (JP)

(21) Appl. No.: 14/773,282

(22) PCT Filed: Mar. 4, 2014
(86) PCT No.: PCT/JP2014/055456

§ 371 Date: Sep. 4, 2015

(30) Foreign Application Priority Data
Mar. 5, 2013 (JP) 2013-043196
Mar. 3, 2014 (JP) 2014-040369

(51) Int. Cl. C09J 167/02

(52) U.S. Cl. CPC C09J 167/02

(57) ABSTRACT

Provided is a double-sided pressure-sensitive adhesive tape that is for fixing an electronic device component, has excellent adhesion, retention, and repulsion resistance, and can be produced with a plant-derived material having a high biomass degree. This double-sided pressure-sensitive adhesive tape for fixing an electronic device component is characterized by comprising a pressure-sensitive adhesive layer having a biomass degree of 50% by weight or more.

### TECHNICAL FIELD

The invention relates to a double-sided pressure-sensitive adhesive tape for fixing an electronic device component.

### BACKGROUND ART

In recent years, cellular phones, digital cameras, PDAs, digital video cameras, and other OA devices, and electronic components (particularly mobile devices) have increased in functionality and decreased in size and thickness as they have become widespread and increased in production. For example, cellular phones as typical mobile devices tend to have thinner main components so that they can be easier to carry and have a wider display screen.

In general, a display part composed mainly of an LCD module and a backlight unit has various many sheet-shaped components (placed on one another) for performing functions such as light emission, reflection, light shielding, and light guiding. Double-sided pressure-sensitive adhesive tapes and the like are generally used in assembling (bonding) these components (see Patent Document 1).

Silicone-based pressure-sensitive adhesives, acrylic pressure-sensitive adhesives, and the like are typically used as raw materials for double-sided adhesive tapes. Silicone-based pressure-sensitive adhesives are expensive and less economical. On the other hand, acrylic pressure-sensitive adhesives are inexpensive but may contribute to the problem of oil resources depletion because petroleum is often used as a raw material for them. In addition, carbon dioxide is emitted in the process of disposal of acrylic pressure-sensitive adhesives after use, which is not global-environmentally conscious. There has been a demand for measures against global warming, and the use of plant-derived raw materials, which are renewable materials, has been recommended.

### PRIOR ART DOCUMENT

### Patent Document

Patent Document 1: JP-A-2002-249741

### SUMMARY OF THE INVENTION

### Problems to be Solved by the Invention

Under these circumstances, it is therefore an object of the invention to provide a double-sided pressure-sensitive adhesive tape that is suitable for fixing an electronic device component and produced with a plant-derived raw material friendly to the global environment and has a high biomass degree and a high level of adhesion, retention, and repulsion resistance.

### Means for Solving the Problems

As a result of earnest studies to solve the problems, the inventors have found the double-sided pressure-sensitive adhesive tape, shown below, for fixing an electronic device component and accomplished the invention.

Specifically, the invention is directed to a double-sided pressure-sensitive adhesive tape for fixing an electronic device component, the double-sided pressure-sensitive adhesive tape including a pressure-sensitive adhesive layer having a biomass degree of 50% by weight or more.

The double-sided pressure-sensitive adhesive tape of the invention for fixing an electronic device component preferably has a holding power of 0.8 mm/60 minutes or less at 40° C.

The double-sided pressure-sensitive adhesive tape of the invention for fixing an electronic device component preferably has a lifting distance of 180 μm or less as a measure of repulsion resistance.

The double-sided pressure-sensitive adhesive tape of the invention for fixing an electronic device component preferably further includes a release liner provided on at least one side of the pressure-sensitive adhesive layer.

The double-sided pressure-sensitive adhesive tape of the invention for fixing an electronic device component preferably include at least two pressure-sensitive adhesive layers and a support provided on at least one side of the pressure-sensitive adhesive layer.

### Effect of the Invention

The invention makes it possible to provide a double-sided pressure-sensitive adhesive tape that is suitable for specialized applications for fixing electronic device components and produced with a plant-derived raw material friendly to the global environment and has a high biomass degree and a high level of adhesion, retention, and repulsion resistance. Therefore, the invention is useful.

### BRIEF DESCRIPTION OF THE DRAWINGS

FIG. 1 is a diagram showing the state of a sample with which the lifting distance is evaluated as a measure of repulsion resistance.

FIG. 2 is a diagram showing the state of a double-sided pressure-sensitive adhesive tape including a pressure-sensitive adhesive layer and release liners attached to both surfaces of the pressure-sensitive adhesive layer.

FIG. 3 is a diagram showing the state of a double-sided pressure-sensitive adhesive tape including a support, pressure-sensitive adhesive layers provided on both surfaces of the support, and a release liner attached to the surface of each pressure-sensitive adhesive layer.

### MODE FOR CARRYING OUT THE INVENTION

Hereinafter, embodiments of the invention will be described in detail.

<Double-Sided Pressure-Sensitive Adhesive Tape>

The double-sided pressure-sensitive adhesive tape of the invention for fixing an electronic device component (also simply referred to as the double-sided pressure-sensitive adhesive tape or the pressure-sensitive adhesive tape) may be of any type as long as it has a pressure-sensitive adhesive layer with a biomass degree of 50% by weight or more. FIG. 2 shows an example of the double-sided pressure-sensitive adhesive tape (with no support), which includes a pressure-sensitive adhesive layer and release liners attached to both surfaces of the pressure-sensitive adhesive layer. FIG. 3 shows another example of the double-sided pressure-sensitive adhesive tape (with a support), which includes a support, pressure-sensitive adhesive layers provided on both surfaces of the support, and release liners each attached to the surface of each pressure-sensitive adhesive layer. The pressure-sensitive adhesive layer may be a stack (laminate) of two or more pressure-sensitive adhesive sub-layers bonded together and made of the same or different materials. The double-sided pressure-sensitive adhesive tape may include two or more support and three or more pressure-sensitive adhesive layers.

The double-sided pressure-sensitive adhesive tape of the invention has a pressure-sensitive adhesive layer with a biomass degree of 50% by weight or more, preferably 60% by weight or more, more preferably 70% by weight or more. The pressure-sensitive adhesive obtained with a high biomass degree of 50% by weight or more is environmentally compatible or friendly to the global environment, which is a preferred mode. As used herein, the term “biomass degree” means the calculated ratio of the weight of the plant-derived raw material used in the production of the pressure-sensitive adhesive layer to the total weight of the pressure-sensitive adhesive layer (the total weight of all the raw materials used to form the pressure-sensitive adhesive composition).

As used herein, the term “electronic device” refers to portable electronic (electric) devices such as cellular phones, smartphones, tablet PCs, portable music players, and PDAs, digital cameras, videos, car navigation systems, personal computers, televisions, game machines, and the like. For example, for portable electronic devices, the term “for fixing an electronic device component” means to be used for fixing an exterior part such as a housing or an exterior lens, to be used for fixing an interior part such as an LCD unit, a reflective sheet, a backlight unit, a frame therefor, or an FPC, or to be used for fixing a functional component such as a battery, a heat radiation sheet, an electromagnetic wave shield or a member therefor, or an antenna member.

The pressure-sensitive adhesive layer may be formed using any of various pressure-sensitive adhesives, such as rubber-based pressure-sensitive adhesives, acrylic pressure-sensitive adhesives, silicone-based pressure-sensitive adhesives, polyamide-based pressure-sensitive adhesives, polyurethane-based pressure-sensitive adhesives, vinyl alkyl ether-based pressure-sensitive adhesives, polyvinyl alcohol-based pressure-sensitive adhesives, polyvinylpyrrolidone-based pressure-sensitive adhesives, polyacrylamide-based pressure-sensitive adhesives, cellulose-based pressure-sensitive adhesives, polyester-based pressure-sensitive adhesives, or fluorinated pressure-sensitive adhesives. In particular, pressure-sensitive adhesives producible from plant-derived raw materials are useful, such as rubber-based pressure-sensitive adhesives (such as natural rubber), polyurethane-based pressure-sensitive adhesives, polyamide-based pressure-sensitive adhesives, or polyester-based pressure-sensitive adhesives.

Among these pressure-sensitive adhesives, polyester-based pressure-sensitive adhesives are particularly useful because of the following reasons. Expensive silicone-based pressure-sensitive adhesives or petroleum-based acrylic pressure-sensitive adhesives should not be used. Polyester-based pressure-sensitive adhesives with a high biomass degree and a high level of adhesion, retention, and repulsion resistance can be obtained using plant-derived raw materials that are friendly to the global environment and do not raise the problem of fossil resources depletion or carbon dioxide emission. Therefore, the use of a polyester-based pressure-sensitive adhesive is a preferred mode.

<Polyester-Based Pressure-Sensitive Adhesive>

In a preferred mode, a polyester obtained by polycondensation of at least a carboxylic acid component and a diol component is used to form the polyester-based pressure-sensitive adhesive. Such a polyester may be synthesized by any known polymerization techniques without limitation.

In a preferred mode, the polyester is produced from plant-derived raw materials. This is because plant-derived raw materials, which are said to be carbon neutral, can be used to produce global environment-friendly or environmentally compatible pressure-sensitive adhesives.

The polyester includes a carboxylic acid component. The carboxylic acid component preferably includes at least a component derived from a dicarboxylic acid containing two carboxyl groups.

Examples of the dicarboxylic acid include plant-derived dicarboxylic acids such as sebacic acid derived from castor oil, oleic acid, and dimer acids derived from erucic acid or the like; and other dicarboxylic acids such as aliphatic or alicyclic dicarboxylic acids such as adipic acid, azelaic acid, 1,4-cyclohexanedicarboxylic acid, 4-methyl-1,2-cyclohexanedicarboxylic acid, dodecenyl succinic anhydride, fumaric acid, succinic acid, dodecanedioic acid, hexahydrophthalic anhydride, tetrahydrophthalic anhydride, maleic acid, maleic anhydride, itaconic acid, and citraconic acid; and terephthalic acid, isophthalic acid, orthophthalic acid, 1,5-naphthalenedicarboxylic acid, 2,6-naphthalenedicarboxylic acid, 4,4′-diphenyldicarboxylic acid, 2,2′-diphenyldicarboxylic acid, and 4,4′-diphenyl ether dicarboxylic acid. In particular, dimer acids and the like are preferred because they can be derived from plants and therefore global environment-friendly. These dicarboxylic acids may be used alone or in combination of two or more.

In addition to the dicarboxylic acid, a tricarboxylic acid containing three or more carboxyl groups may also be used. However, when a polyfunctional carboxylic acid such as a tricarboxylic acid is used, a network structure (three-dimensional crosslinked structure) can be formed so that the adhering strength (adhesive strength) of the pressure-sensitive adhesive layer (pressure-sensitive adhesive tape) can be kept low. Therefore, when high adhesion is necessary, the tricarboxylic acid and the like should preferably not be used.

The polyester also includes a diol component. The diol component preferably includes a component derived from a compound having at least two hydroxyl groups per molecule.

Examples of the diol component include plant-derived diols such as fatty acid esters derived from castor oil, dimer diols derived from oleic acid, erucic acid, or the like, and glycerol monostearate; and other diols including aliphatic glycols such as ethylene glycol, 1,2-propylene glycol, 1,3-propanediol, 2-methyl-1,3-propanediol, 1,2-butanediol, 1,3-butanediol, 1,4-butanediol, 1,5-pentanediol, 1,6-hexanediol, 3-methyl-1,5-pentanediol, neopentyl glycol, diethylene glycol, dipropylene glycol, 2,2,4-trimethyl-1,5-pentanediol, 2-ethyl-2-butylpropanediol, 1,9-nonanediol, 2-methyloctanediol, 1,10-decanediol, 1,4-cyclohexanedimethanol, and 1,2-cyclohexanedimethanol; and diols other than the aliphatic glycols, such as ethylene oxide adducts of bisphenol A, propylene oxide adducts of bisphenol A, ethylene oxide adducts of hydrogenated bisphenol A, propylene oxide adducts of hydrogenated bisphenol A, polytetramethylene glycol, polypropylene glycol, polyethylene glycol, and polycarbonate glycol. In particular, plant-derived aliphatic diols are preferred because they are global environment-friendly. These diols may be used alone or in combination of two or more.

The molar ratio of the carboxylic acid component to the diol component is preferably 1:1.04 to 2.10, more preferably 1:1.06 to 1.70, even more preferably 1:1.07 to 1.30. If the molar ratio is lower than 1:1.04, the resulting polyester can have a higher molecular weight and a smaller number of hydroxyl groups as functional groups, so that the crosslinking reaction of the polyester can be difficult to speedup even when a crosslinking agent (such as a polyfunctional isocyanate) is used, which can make it impossible to obtain a pressure-sensitive adhesive layer with a desired gel fraction. In this case, the pressure-sensitive adhesive (layer) may fail to have a sufficient holding power (cohesive strength). On the other hand, if the molar ratio is more than 1:2.10, only a polyester with a molecular weight smaller than the desired value will tend to form. That is not preferred because gelation of such a polyester cannot be facilitated even when a crosslinking agent is used, so that it will be impossible to obtain a pressure-sensitive adhesive layer having a desired gel fraction.

The polyester used to form the double-sided pressure-sensitive adhesive tape (pressure-sensitive adhesive composition) of the invention preferably has a weight average molecular weight (Mw) of 5,000 to 60,000, more preferably 8,000 to 50,000, even more preferably 15,000 to 45,000. If the weight average molecular weight is less than 5,000, the pressure-sensitive adhesive including the polyester can have lower adhering strength (adhesive strength), so that the resulting pressure-sensitive adhesive tape (pressure-sensitive adhesive layer) itself cannot be secured to electronic device components or other adherends in some cases. If the weight average molecular weight is more than 60,000, the content of hydroxyl groups as functional groups will be relatively low, so that the crosslinking reaction of the polyester can be difficult to speed up even when a crosslinking agent (such as a polyfunctional isocyanate) is used, which can make it difficult to obtain a pressure-sensitive adhesive layer with a desired gel fraction, and therefore is not preferred.

An additional component other than the carboxylic acid component and the diol component may be introduced into the polyester by polymerization or addition after the polymerization as long as it does not degrade the properties of the polyester to be used in the double-sided pressure-sensitive adhesive tape of the invention.

In the invention, the polymerization (polycondensation) reaction of the dicarboxylic acid component and the diol component may be performed by a conventionally known method with or without a solvent.

The method for removing water produced in the polymerization (polycondensation) reaction may be a method of removing water by azeotrope with toluene or xylene, a method of blowing inert gas into the reaction system so that the produced water and monoalcohol can be discharged together with the inert gas to the outside of the reaction system, a method of removing water by distillation under reduced pressure, or the like.

Any polymerization catalyst generally used for polyester may be used in the polymerization (polycondensation) reaction. Examples of polymerization catalysts that may be used include, but are not limited to, various metal compounds such as titanium compounds, tin compounds, antimony compounds, zinc compounds, and germanium compounds, and strong acid compounds such as p-toluenesulfonic acid and sulfuric acid.

<Rubber-Based Pressure-Sensitive Adhesive>

Examples of rubber polymers that may be used to form the rubber-based pressure-sensitive adhesives include natural rubber, copolymers of natural rubber and an acrylic component such as methyl methacrylate, polyisoprene rubber (IR), butyl rubber (IIR), polyisobutylene rubber (PBI), styrene-isoprene-styrene block copolymers (SIS) and hydrogenation products thereof (SEPS), hydrogenated styrene-butadiene rubber (HSBR), and styrene-butadiene-styrene block copolymers (SBS) and hydrogenation products thereof (SEBS). Among them, natural rubber is particularly preferred because it is a plant-derived raw material and the use of it can increase the biomass degree. These rubber polymers may be used alone or in combination of two or more.

<Crosslinking Agent>

The double-sided pressure-sensitive adhesive tape (pressure-sensitive adhesive composition) of the invention may contain a crosslinking agent. The pressure-sensitive adhesive composition containing the crosslinking agent can form a pressure-sensitive adhesive layer by a crosslinking reaction. The crosslinking agent may be any conventionally known crosslinking agent such as a polyvalent isocyanurate, a polyfunctional isocyanate, a polyfunctional melamine compound, a polyfunctional epoxy compound, a polyfunctional oxazoline compound, a polyfunctional aziridine compound, a metal chelate compound, or the like. Particularly in view of versatility, a polyvalent isocyanurate or a polyfunctional isocyanate compound is preferably used. These crosslinking agents may be used alone or in combination of two or more.

Examples of the polyvalent isocyanurate include a polyisocyanurate of hexamethylene diisocyanate and the like. The polyvalent isocyanurate can be effectively used for the purpose of obtaining a pressure-sensitive adhesive layer with high transparency or high gel fraction. The polyvalent isocyanurate to be used may be a commercially available product such as Duranate TPA-100 (trade name) manufactured by Asahi Kasei Chemicals Corporation and CORONATE HK (trade name), CORONATE HX (trade name), CORONATE 2096 (trade name) manufactured by Nippon Polyurethane Industry Co., Ltd.

The polyfunctional isocyanate compound is preferably, for example, a compound having at least two isocyanate groups per molecule. More preferably, the polyfunctional isocyanate compound is any compound having three or more isocyanate groups per molecule. Examples include aliphatic polyisocyanates, alicyclic polyisocyanates, aromatic polyisocyanates, and the like.

Examples of the aliphatic polyisocyanates include 1,2-ethylene diisocyanate, tetramethylene diisocyanates such as 1,2-tetramethylene diisocyanate, 1,3-tetramethylene diisocyanate, and 1,4-tetramethylene diisocyanate; hexamethylene diisocyanates such as 1,2-hexamethylene diisocyanate, 1,3-hexamethylene diisocyanate, 1,4-hexamethylene diisocyanate, 1,5-hexamethylene diisocyanate, 1,6-hexamethylene diisocyanate, and 2,5-hexamethylene diisocyanate; and 2-methyl-1,5-pentane diisocyanate, 3-methyl-1,5-pentane diisocyanate, and lysine diisocyanate.

Examples of the alicyclic polyisocyanates include isophorone diisocyanate; cyclohexyl diisocyanates such as 1,2-cyclohexyl diisocyanate, 1,3-cyclohexyl diisocyanate, and 1,4-cyclohexyl diisocyanate; cyclopentyl diisocyanates such as 1,2-cyclopentyl diisocyanate and 1,3-cyclopentyl diisocyanate; hydrogenated xylylene diisocyanate, hydrogenated tolylene diisocyanate, hydrogenated diphenylmethane diisocyanate, hydrogenated tetramethylxylene diisocyanate, and 4,4′-dicyclohexylmethane diisocyanate.

Examples of the aromatic polyisocyanates include 2,4-tolylene diisocyanate, 2,6-tolylene diisocyanate, 4,4′-diphenylmethane diisocyanate, 2,4′-diphenylmethane diisocyanate, 2,2′-diphenylmethane diisocyanate, 4,4′-diphenylether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropane diisocyanate, m-phenylene diisocyanate, p-phenylene diisocyanate, naphthylene-1,4-diisocyanate, naphthylene-1,5-diisocyanate, 3,3′-dimethoxydiphenyl-4,4′-diisocyanate, xylylene-1,4-diisocyanate, and xylylene-1,3-diisocyanate.

Besides the aliphatic, alicyclic, and aromatic polyisocyanates, examples of the polyfunctional isocyanate compound that may be used include dimers or trimers of aromatic aliphatic polyisocyanates, such as dimers or trimers of diphenylmethane diisocyanate, a reaction product of trimethylolpropane and tolylene diisocyanate, a reaction product of trimethylolpropane and hexamethylene diisocyanate, polymethylene polyphenyl iso cyanate, polyether-polyisocyanate, polyester-polyisocyanate, and other polymers.

Commercially available products of the polyfunctional isocyanate compound may also be used, examples of which include CORONATE L (trade name, manufactured by Nippon Polyurethane Industry Co., Ltd.) as a trimer adduct of trimethylolpropane and tolylene diisocyanate, and CORONATE HL (trade name, manufactured by Nippon Polyurethane Industry Co., Ltd.) as a trimer adduct of trimethylolpropane and hexamethylene diisocyanate.

Examples of the polyfunctional melamine compound include methylated methylolmelamine and butylated hexamethylolmelamine, and examples of the polyfunctional epoxy compound include diglycidyl aniline and glycerin diglycidyl ether.

Examples of the crosslinking agent (vulcanizing agent) that may be appropriately used in the rubber-based pressure-sensitive adhesive include a sulfur crosslinking agent, a thiuram crosslinking agent, a peroxide crosslinking agent, a quinoid crosslinking agent, a resin crosslinking agent, an amine crosslinking agent, a metal oxide crosslinking agent, an isocyanate crosslinking agent, and a phenolic resin crosslinking agent. In particular, a phenolic resin crosslinking agent is preferred because it has high heat resistance. The phenolic resin crosslinking agent may be a condensation product of formaldehyde and any of various phenols such as phenol, m-cresol, 3,5-xylenol, p-alkylphenol, and resorcin. An alkylphenol resin is preferred because it can also function as a tackifier.

The type and content of the crosslinking agent are not particularly restricted. When formed in the double-sided pressure-sensitive adhesive tape, the pressure-sensitive adhesive layer preferably has a gel fraction of less than 40% by weight, more preferably 20 to less than 40% by weight, even more preferably 20 to less than 39.8% by weight, further more preferably 30 to 39.6% by weight. The pressure-sensitive adhesive layer with a gel fraction of more than 40% by weight is not preferred because it can fail to have repulsion resistance or fail to be suitable for applications for fixing electronic device components.

The amount of the crosslinking agent is preferably from 0.5 to 30 parts by weight, more preferably from 1 to 20 parts by weight, based on 100 parts by weight of the polymer (such as the polyester or the rubber polymer) as a main component of the pressure-sensitive adhesive. If the amount is less than 0.5 parts by weight, it may be impossible to improve the holding power (cohesive strength) of the pressure-sensitive adhesive layer, or the heat resistance may decrease. If the amount is more than 30 parts by weight, the crosslinking reaction may proceed excessively to reduce the adhering strength, which is not suitable for applications for fixing electronic device components and not preferred.

A crosslinking catalyst may be used as needed to efficiently control the gel fraction of the pressure-sensitive adhesive layer used to form the double-sided pressure-sensitive adhesive tape of the invention. Examples of the catalyst include tetra-n-butyl titanate, tetraisopropyl titanate, butyltin oxide, dioctyltin dilaurate, and the like. These catalysts may be used alone or in combination of two or more.

The amount of the catalyst is preferably, but not limited to, 0.01 to 1 part by weight, more preferably 0.05 to 0.5 parts by weight, based on 100 parts by weight of the polymer (such as the polyester) as a main component of the pressure-sensitive adhesive. If the amount is less than 0.01 parts by weight, the addition of the catalyst may fail to be effective, and if the amount is more than 1 part by weight, the pressure-sensitive adhesive may have a significantly short shelf-life and decrease in application stability.

To extend the shelf life, a retarder such as acetyl acetone, methanol, or methyl orthoacetate may be added as needed.

<Tackifier>

A combination of the crosslinking agent and a tackifier may be added to the polymer (such as the polyester or the rubber polymer) used as a main component of the pressure-sensitive adhesive to form the pressure-sensitive adhesive layer for the double-sided pressure-sensitive adhesive tape of the invention. In this case, the resulting pressure-sensitive adhesive layer can have desired properties and is particularly expected to have higher adhesion (adherability) or higher repulsion resistance.

The tackifier is not restricted and may be any conventionally known one, examples of which include a terpene-based tackifier, a phenol-based tackifier, a rosin-based tackifier, an aliphatic petroleum resin, an aromatic petroleum resin, a copolymer-based petroleum resin, an alicyclic petroleum resin, a xylene resin, an epoxy-based tackifier, a polyamide-based tackifier, a ketone-based tackifier, and an elastomer-based tackifier. In particular, a rosin- or terpene-based tackifier produced from a plant-derived raw material is preferably used so that the biomass degree can be increased. One of these may be used, or two or more of these may be used in combination.

Examples of the terpene-based tackifier include a terpene resin, a terpene phenol resin, and an aromatic modified terpene resin, and specific examples that may be used include an α-pinene polymer, a β-pinene polymer, a dipentene polymer, and modifications thereof, such as a phenol-modified terpene-based resin, an aromatic modified terpene-based resin, a hydrogenated modified terpene-based resin, and a hydrocarbon-modified terpene-based resin.

Examples of the phenol-based tackifier that may be used include condensation products of formaldehyde and any of various phenols such as phenol, m-cresol, 3,5-xylenol, p-alkylphenol, and resorcin. Further examples that may be used include resols obtained by addition reaction of formaldehyde and any of the phenols in the presence of an alkali catalyst; novolac resins obtained by condensation reaction of formaldehyde and any of the phenols in the presence of an acid catalyst; and rosin-modified phenolic resins obtained by addition reaction of phenol with any of rosins such as unmodified or modified rosin and derivatives thereof and thermal polymerization of the addition product.

Examples of the rosin-based tackifier include a rosin resin, a polymerized rosin resin, a hydrogenated rosin resin, a rosin ester resin, a hydrogenated rosin ester resin, and a rosin phenol resin. Specific examples that may be used include unmodified rosin (raw rosin) such as gum rosin, wood rosin, or tall oil rosin, modified rosin obtained by hydrogenation, disproportionation, polymerization, or any other chemical modification thereof, and derivatives thereof.

In particular, the tackifier preferably has a softening point of 100 to 170° C., more preferably 110 to 165° C., even more preferably 120 to 165° C., as measured by ring and ball method. When the softening point falls within these ranges, adhesion and repulsion resistance can be improved at the same time, which is preferred.

The amount of the tackifier is preferably 0 to 150 parts by weight, more preferably 25 to 120 parts by weight, even more preferably 35 to 100 parts by weight, based on 100 parts by weight of the polymer (such as the polyester or the rubber polymer) as a main component of the pressure-sensitive adhesive. If the amount is more than 150 parts by weight, the pressure-sensitive adhesive layer may fail to have a gel fraction in the desired range or decrease in adhering strength, which is not preferred.

When used to from the double-sided pressure-sensitive adhesive tape of the invention, the pressure-sensitive adhesive layer (pressure-sensitive adhesive) may contain a general additive such as a silane coupling agent, a surface lubricant, a leveling agent, an antioxidant, a polymerization inhibitor, an ultraviolet absorber, a light stabilizer, a release modifier, a plasticizer, a softening agent, an inorganic or organic filler, a colorant such as a pigment or a dye, an age resistor, a surfactant, a metal powder, or a particulate or flaky material, as long as the properties of the pressure-sensitive adhesive layer (pressure-sensitive adhesive) are not impaired.

The thickness of the pressure-sensitive adhesive layer (after drying) may be selected as appropriate. For example, the pressure-sensitive adhesive layer (after drying) preferably has a thickness of about 1 to about 150 μm, more preferably about 3 to about 100 μm, even more preferably about 5 to about 60 μm. If the pressure-sensitive adhesive layer has a thickness of less than 1 μm, sufficient adhering strength (adhesive strength) can be difficult to obtain, and the pressure-sensitive adhesive tape (pressure-sensitive adhesive layer) itself may fail to be secured to or may easily peel off from an adherend such as an electronic device component. If the thickness is more than 150 μm, variations in thickness can easily occur during the coating process, which is not preferred. The pressure-sensitive adhesive layer may have a single-layer or multilayer structure.

The double-sided pressure-sensitive adhesive tape of the invention for fixing an electronic device component preferably includes at least two layers of the pressure-sensitive adhesive and a support that is provided on at least one side of the pressure-sensitive adhesive layer. With a support provided on at least one side of the pressure-sensitive adhesive layer, the double-sided pressure-sensitive adhesive tape can have improved mechanical strength or improved workability, which is a preferred mode.

<Support>

The support may be of any conventionally known type, such as a plastic film, a paper sheet, a porous material such as a nonwoven fabric, or any of various other supports (backings). In view of durability or the like, a plastic film is preferably used for applications for fixing electronic (electric) device components. The plastic film may be, for example, a film of polyolefin such as polyethylene, polypropylene, poly-1-butene, poly-4-methyl-1-pentene, an ethylene-propylene copolymer, an ethylene-1-butene copolymer, an ethylene-vinyl acetate copolymer, an ethylene-ethyl acrylate copolymer, or an ethylene-vinyl alcohol copolymer, a film of polyester such as polyethylene terephthalate, polyethylene naphthalate, or polybutylene terephthalate, a polyacrylate film, a polystyrene film, a film of polyamide such as nylon 6, nylon 6,6, or partially aromatic polyamide, a polyvinyl chloride film, a polyvinylidene chloride film, a polycarbonate film, or the like. A support made of polylactic acid or cellulose obtained from plant-derived raw materials is preferably used because it can increase the total biomass degree of the double-sided pressure-sensitive adhesive tape.

If necessary, the support may contain any of various additives used in backings (supports) for general pressure-sensitive adhesive tapes, such as an ultraviolet absorber, a light stabilizer, an antioxidant, an antistatic agent, a filler, a pigment, and a dye.

If necessary, the surface of the support may be subjected to a common surface treatment for improving its adhesiveness to the pressure-sensitive adhesive layer, such as a chromic acid treatment, exposure to ozone, exposure to flame, exposure to high-voltage electric shock, an ionizing radiation treatment or other chemical or physical oxidation treatments, or a coating treatment with a priming agent. The surface of the support may also be subjected to an antifouling treatment with silica powder or an antistatic treatment of a coating, kneading, or vapor-deposition type.

When used to form the double-sided pressure-sensitive adhesive tape of the invention, the support may also have an intermediate layer or an undercoat layer with no problem as long as the properties of the support are not impaired.

The thickness of the support may be appropriately selected depending on the material or shape of the support. For example, the support preferably has a thickness of 1,000 μm or less, more preferably about 1 to about 1,000 μm, even more preferably about 2 to about 500 μm, further more preferably about 3 to about 300 μm, still more preferably about 5 to about 250 μm.

The pressure-sensitive adhesive layer may be formed using any conventionally known method. For example, the pressure-sensitive adhesive layer may be formed according to a known method for producing a pressure-sensitive adhesive tape (pressure-sensitive adhesive sheet), such as a method that includes applying the pressure-sensitive adhesive composition (a solution of the pressure-sensitive adhesive composition in a solvent or a hot melt thereof) to the support and drying the composition to form a pressure-sensitive adhesive layer; a method that includes applying the pressure-sensitive adhesive composition to the support, drying the composition to form a pressure-sensitive adhesive composition layer, and further crosslinking it to form a pressure-sensitive adhesive layer; a method that includes forming a pressure-sensitive adhesive layer on a release liner by coating and then moving (transferring) the pressure-sensitive adhesive layer onto the support; a method of applying a pressure-sensitive adhesive layer-forming material to the support by extrusion; a method of extruding a support and a pressure-sensitive adhesive layer in two or more layers; or a method of laminating a single pressure-sensitive adhesive layer onto the support. The pressure-sensitive adhesive layer may also be formed using a method of co-extruding a thermoplastic resin support and a pressure-sensitive adhesive layer in two or more layers by inflation method or T-die method. As used herein, the term “double-sided pressure-sensitive adhesive tape” is intended to include a pressure-sensitive adhesive film, a pressure-sensitive adhesive sheet, a support-free double-sided pressure-sensitive adhesive tape (pressure-sensitive adhesive layer alone), a double-sided pressure-sensitive adhesive tape containing a support, and the like.

The pressure-sensitive adhesive composition (solution) may be applied using a conventionally known method such as roll coating, gravure coating, reverse roll coating, roll brush coating, air knife coating, spray coating, or extrusion coating with a die coater or the like.

A release liner is preferably provided on at least one side of the pressure-sensitive adhesive layer according to the invention. A release liner or liners provided on one or both sides of the pressure-sensitive adhesive layer can protect and preserve the surface of the pressure-sensitive adhesive layer until the pressure-sensitive adhesive layer (double-sided pressure-sensitive adhesive tape) is used, and are also useful for workability and the like.

<Release Liner>

The release liner may be any conventionally-known appropriate release liner. For example, the release liner to be used may include a backing (a backing for a release liner) and a release coating layer that is formed on at least one side of the backing by a coating treatment with a parting agent (release agent) for imparting releasability, such as a silicone release agent, a fluoride release agent, a long-chain alkyl release agent, or a fatty acid amide release agent. The backing for the release liner may have a single-layer or multilayer structure.

Any of various thin materials such as plastic films, paper sheets, foamed products, and metal foils may be used as the release liner backing. A plastic film is particularly preferred. Examples of the material for the plastic film include polyester such as polyethylene terephthalate, polyolefin such as polypropylene or ethylene-propylene copolymer, and thermoplastic resin such as polyvinyl chloride. A plastic film including polylactic acid, polyester, or polyamide obtained from a plant-derived raw material is also preferably used.

The thickness of the release liner backing may be selected as appropriate, depending on the purpose.

The whole of the double-sided pressure-sensitive adhesive tape of the invention (including all the components such as the pressure-sensitive adhesive layer, the support, and the release liner) preferably has a biomass degree of 25% by weight or more, more preferably 30% by weight or more. With a biomass degree of 25% by weight or more, the whole of the resulting double-sided pressure-sensitive adhesive tape is environmentally compatible or friendly to the global environment, which is a preferred mode. As used herein, the term “biomass degree” means the calculated ratio of the weight of the plant-derived raw material used in the production of the double-sided pressure-sensitive adhesive tape to the total weight of the double-sided pressure-sensitive adhesive tape (the total weight of all the raw materials used to form the components such as the pressure-sensitive adhesive layer and the support).

### EXAMPLES

Hereinafter, the invention will be more specifically described with reference to examples, which however are not intended to limit the invention. In the examples, “parts” refers to “parts by weight,” and “%” refers to “% by weight.” The composition of pressure-sensitive adhesive layers (double-sided pressure-sensitive adhesive tapes) and evaluation results are shown in Table 1.

<Preparation of Polyester A>

A three-necked separable flask equipped with a stirrer, a thermometer, and a vacuum pump was charged with 98.24 g of a dimer acid (Pripol 1009 (trade name) manufactured by Croda, 567 in molecular weight), 101.76 g of a dimer diol (Pripol 2033 (trade name) manufactured by Croda, 537 in molecular weight), and 0.2 g of dibutyltin oxide (manufactured by Wako Pure Chemical Industries, Ltd.) as a catalyst. The mixture was heated to 200° C. with stirring under a reduced-pressure atmosphere (2.0 kPa or less), and then this temperature was maintained. The reaction was continued for about 3 hours to produce polyester A, which had a weight average molecular weight (Mw) of 31,000.

The dimer acid and the dimer diol were used in such amounts that the amount of the hydroxyl group in the dimer diol was 1.09 moles per 1.00 mole of the carboxyl group in the dimer acid.

<Preparation of Polyester B>

Polyester B was obtained in the same way as for polyester A, except that the amount of the dimer acid was changed to 93.02 g and the amount of the dimer diol was changed to 106.98 g. Polyester B had a weight average molecular weight (Mw) of 19,000.

The dimer acid and the dimer diol were used in such amounts that the amount of the hydroxyl group in the dimer diol was 1.21 moles per 1.00 mole of the carboxyl group in the dimer acid.

### Example 1

To 100 parts of polyester A were added 3.5 parts of hexamethylene diisocyanate (TPA-100 (trade name) manufactured by Asahi Kasei Chemicals Corporation) as a crosslinking agent and 40 parts of rosin ester (PENSEL D125 (trade name) manufactured by Arakawa Chemical Industries, Ltd.) as a tackifier. A pressure-sensitive adhesive was prepared by adding toluene to the mixture so that a solids content of 70% would be reached. The pressure-sensitive adhesive was applied to the release-treated surface of a release-treated polyethylene terephthalate (PET) film (Diafoil MRF #38 (trade name) manufactured by Mitsubishi Plastics, Inc.) so that a 30-μm-thick coating would be formed after drying. The coating was dried at 120° C. for 3 minutes to form a pressure-sensitive adhesive layer. Subsequently, the pressure-sensitive adhesive layer was attached to the release-treated surface of a release-treated polyethylene terephthalate (PET) film (Diafoil MRF #38 (trade name) manufactured by Mitsubishi Plastics, Inc.). The resulting laminate was then allowed to stand at 40° C. for 3 days to give a double-sided pressure-sensitive adhesive tape (see FIG. 2).

### Example 2

A double-sided pressure-sensitive adhesive tape was obtained as in Example 1, except that the tackifier was changed to another type of rosin ester (PENSEL D135 (trade name) manufactured by Arakawa Chemical Industries, Ltd.) and 4 parts of the crosslinking agent was added.

### Example 3

A double-sided pressure-sensitive adhesive tape was obtained as in Example 2, except that 80 parts of the tackifier and 7 parts of the crosslinking agent were added to 100 parts of polyester B.

### Example 4

A double-sided pressure-sensitive adhesive tape was obtained as in Example 3, except that the tackifier was changed to another type of rosin ester (PENSEL D160 (trade name) manufactured by Arakawa Chemical Industries, Ltd.).

### Example 5

A pressure-sensitive adhesive was obtained as in Example 2. The pressure-sensitive adhesive was applied to the release-treated surface of a release-treated polyethylene terephthalate (PET) film (Diafoil MRF #38 (trade name) manufactured by Mitsubishi Plastics, Inc.) so that a 19-μm-thick coating would be formed after drying. The coating was dried at 120° C. for 3 minutes to form a pressure-sensitive adhesive layer. The pressure-sensitive adhesive was also applied in the same way to another release-treated PET film (Diafoil MRE #38 (trade name) manufactured by Mitsubishi Plastics, Inc.), so that two pressure-sensitive adhesive layers were obtained. The two pressure-sensitive adhesive surfaces were bonded to both sides of a 12-μm-thick PET film (Lumirror 12S10 (trade name) manufactured by PANAC Co., Ltd.) as a support. The resulting laminate was then allowed to stand at 40° C. for 3 days to give a double-sided pressure-sensitive adhesive tape (with a support, see FIG. 3).

### Example 6

To 100 parts of natural rubber (RSS1 grade (trade name) available from Nomura Trading Co., Ltd.) were added 50 parts of terpene resin (YS Resin PX1150 (trade name) manufactured by YASUHARA CHEMICAL CO., LTD.) as a tackifier, 10 parts of alkyl phenol resin (TACKIROL 201 (trade name) manufactured by Taoka Chemical Co., Ltd.) as a crosslinking agent, and 1 part of a phenolic antioxidant (IRGANOX 1010 (trade name) manufactured by Ciba-Geigy Corporation) as an age resistor to form a pressure-sensitive adhesive composition. A pressure-sensitive adhesive was prepared by adding toluene to the composition so that a solids content of 30% would be reached. The pressure-sensitive adhesive was applied to the release-treated surface of a release-treated polyethylene terephthalate (PET) film (Diafoil MRF #38 (trade name) manufactured by Mitsubishi Plastics, Inc.) so that a 30-μm-thick coating would be formed after drying. The coating was dried at 150° C. for 3 minutes to form a pressure-sensitive adhesive layer (with the release-treated PET). Subsequently, the pressure-sensitive adhesive layer was attached to the release-treated surface of a release-treated polyethylene terephthalate (PET) film (Diafoil MRF #38 (trade name) manufactured by Mitsubishi Plastics, Inc.) to form a double-sided pressure-sensitive adhesive tape (see FIG. 2).

### Example 7

A pressure-sensitive adhesive was obtained as in Example 6. The pressure-sensitive adhesive was applied to the release-treated surface of a release-treated polyethylene terephthalate (PET) film (Diafoil MRF #38 (trade name) manufactured by Mitsubishi Plastics, Inc.) so that a 19-μm-thick coating would be formed after drying. The coating was dried at 150° C. for 3 minutes to form a pressure-sensitive adhesive layer. The pressure-sensitive adhesive was also applied in the same way to another release-treated PET film (Diafoil MRE #38 (trade name) manufactured by Mitsubishi Plastics, Inc.), so that two pressure-sensitive adhesive layers were obtained. The two pressure-sensitive adhesive surfaces were bonded to both sides of a 12-μm-thick PET film (Lumirror 12S10 (trade name) manufactured by PANAC Co., Ltd.) as a support to forma double-sided pressure-sensitive adhesive tape (with a support, see FIG. 3).

### Comparative Example 1

In a mixed solution of toluene and ethyl acetate [toluene/ethyl acetate=1/1 (in weight ratio)], 70 parts of n-butyl acrylate, 27 parts of 2-ethylhexyl acrylate, 3 parts of acrylic acid, 0.1 parts of 2-hydroxyethyl acrylate, and 0.2 parts of azobisisobutyronitrile as a polymerization initiator were subjected to solution polymerization for 6 hours to form an acryl-based polymer with a weight average molecular weight (Mw) of 500,000. To 100 parts of the acryl-based polymer were added 2 parts of tolylene diisocyanate (CORONATE L (trade name) manufactured by Nippon Polyurethane Industry Co., Ltd.) as a crosslinking agent and 30 parts of a tackifier (PENSEL D125 (trade name) manufactured by Arakawa Chemical Industries, Ltd.). A pressure-sensitive adhesive was prepared by adding toluene to the mixture so that a solids content of 35% would be reached. The pressure-sensitive adhesive was applied to the release-treated surface of a release-treated PET film (Diafoil MRF #38 (trade name) manufactured by Mitsubishi Plastics, Inc.) so that a 13-μm-thick coating would be formed after drying. The coating was dried at 120° C. for 3 minutes to form a pressure-sensitive adhesive layer. The pressure-sensitive adhesive was also applied in the same way to another release-treated PET film (Diafoil MRE #38 (trade name) manufactured by Mitsubishi Plastics, Inc.) to form a pressure-sensitive adhesive layer. Subsequently, the pressure-sensitive adhesive layers were bonded to both sides of a 4-μm-thick PET film as a support, respectively. The resulting laminate was then allowed to stand at 40° C. for 3 days to give a double-sided pressure-sensitive adhesive tape (with a support).

(Weight Average Molecular Weight)

The weight average molecular weight (Mw) of each polymer was determined by a gel permeation chromatography (GPC) method using a solution of the polymer in tetrahydrofuran (THF) and a calibration curve prepared with polystyrene standards.

(Conditions for the Measurement of the Weight Average Molecular Weight of Polyester)

Analyzer: HLC-8220GPC manufactured by Tosoh Corporation
Sample concentration: 0.1% by weight (THF solution)
Sample injection volume: 20 μl

### Eluent: THF

Flow rate: 0.300 ml/min
Measurement (column) temperature: 40° C.

### Columns:

Columns for sample: TSKguard column Super HZ-L (single)+TSKgel Super HZM-M (double) manufactured by Tosoh Corporation
Reference column: TSKgel Super H-RC (single) manufactured by Tosoh Corporation
Detector: differential refractometer (RI)

(Conditions for the Measurement of the Weight Average Molecular Weight of Acryl-Based Polymer)

Analyzer: HLC-8220GPC manufactured by Tosoh Corporation
Sample concentration: 0.2% by weight (THF solution)
Sample injection volume: 10 μl

### Eluent: THF

Flow rate: 0.600 ml/min
Measurement (column) temperature: 40° C.

### Columns:

Columns for sample: TSKguard column Super HZ-H (single)+TSKgel
Super HZM-M (double) manufactured by Tosoh Corporation
Reference column: TSKgel Super H-RC (single) manufactured by Tosoh Corporation
Detector: differential refractometer (RI)

(Gel Fraction of Pressure-Sensitive Adhesive Layer)

The pressure-sensitive adhesive composition (pressure-sensitive adhesive solution) in each of the examples and the comparative example was applied to a release liner to form a pressure-sensitive adhesive layer with a thickness of 30 μm (the thickness obtained after the pressure-sensitive adhesive composition was dried and crosslinked). Subsequently, a 5 cm×5 cm square piece was cut from the resulting pressure-sensitive adhesive layer, and the release liner was removed. The resulting piece was used as a test piece.

The test piece was wrapped in a Teflon (registered trademark) sheet (simply referred to as the “sheet” in the formula below), whose weight had been measured, and then subjected to weighing. The wrapped test piece was allowed to stand in toluene at 23° C. for 7 days, and then the sol fraction was extracted from the test piece. Subsequently, the test piece was dried at 120° C. for 2 hours, and its dried weight was measured. The gel fraction of the sample was calculated from the following formula.

Gel fraction (% by weight)=100×(the weight after the drying−the weight of the sheet)/(the weight before the drying−the weight of the sheet)

The pressure-sensitive adhesive layer preferably has a gel fraction of less than 40% by weight, more preferably 20 to less than 40% by weight, even more preferably 20 to less than 39.8% by weight, furthermore preferably 30 to less than 39.6% by weight. If the gel fraction is more than 40% by weight, it can be difficult to simultaneously achieve good retention and good repulsion resistance, which is not preferred.

(Biomass Degree of Pressure-Sensitive Adhesive Layer)

The biomass degree is the ratio of the weight of plant-derived raw materials used in the production of the pressure-sensitive adhesive layer to the total weight of the pressure-sensitive adhesive layer, which was calculated from the following formula.

The biomass degree (% by weight) of the pressure-sensitive adhesive layer=100×[the weight (g) of the plant-derived raw materials]/[the total weight (g) of the pressure-sensitive adhesive layer]

The biomass degree is 50% by weight or more, preferably 60% by weight or more, more preferably 70% by weight or more. A biomass degree of less than 50% is not preferred in view of fossil resource depletion or carbon dioxide emission.

(Adhering Strength to Polycarbonate (PC) Plate)

One of the release-treated films was peeled off from the resulting double-sided pressure-sensitive adhesive tape. The exposed pressure-sensitive adhesive surface was then bonded to a 25-μm-thick polyethylene terephthalate (PET) film (Lumirror 25S10 (trade name) manufactured by PANAC Co., Ltd.) to form a test piece.

A 20-mm-wide piece was cut from the test piece, and the other release-treated film was then peeled off. The exposed pressure-sensitive adhesive surface was then bonded to a polycarbonate plate (PC1600 (trade name) manufactured by Takiron Co., Ltd.) to form a test piece, which was measured for adhering strength (N/20 mm) to PC.

In the bonding process, pressure bonding was performed by reciprocating a 2 kg roller once. Thirty minutes after the bonding, the test piece was subjected to 180° peel adhering strength (adhesive strength) measurement with a tensile compression tester (TG-1 kN (tester name) manufactured by Minebea Co., Ltd.) under the following conditions.

Tension (peel) rate: 300 mm/minute

### Measurement Conditions:

### Temperature: 23±2° C.

### Humidity: 65±5% RH

The adhering strength (adhesive strength) to the PC plate is preferably 6 N/20 mm or more, more preferably 7 N/20 mm or more, even more preferably 8 N/20 mm or more. An adhering strength of less than 6 N/20 mm is too low to be suitable for applications for bonding electronic device components and therefore not preferred.

(Holding Power)

One of the release-treated films was peeled off from the resulting double-sided pressure-sensitive adhesive tape. The exposed pressure-sensitive adhesive surface was then bonded to a 25-μm-thick polyethylene terephthalate (PET) film (Lumirror 25S10 (trade name) manufactured by PANAC Co., Ltd.) to form a test piece.

A 10-mm-wide, 100-mm-long piece was cut from the test piece, and the other release-treated film was then peeled off. The exposed pressure-sensitive adhesive surface was then bonded to a 25-mm-wide, 125-mm-long, 2-mm-thick Bakelite plate to form a measurement piece. In the bonding process, the widthwise and longitudinal directions of the test piece were aligned with those of the Bakelite plate, respectively, and the test piece was pressure-bonded to a widthwise central part of the Bakelite plate by reciprocating a 2 kg roller once in such a way that they were lapped at a 10-mm-wide, 20-mm-long area. After the measurement piece was allowed to stand in a 40° C. atmosphere for 30 minutes the test piece was allowed to stand in a 40° C. atmosphere for 1 hour (60 minutes) while being loaded with 0.5 kg. Thereafter, the length (mm/60 minutes) of displacement of the test piece was measured.

The holding power is preferably 0.8 mm/60 minutes or less, more preferably 0.5 mm/60 minutes or less, even more preferably 0.4 mm/60 minutes or less. If the holding power is more than 0.8 mm/60 minutes the pressure-sensitive adhesive tape may slide significantly and fail to stably secure an electronic device component for a long period of time, which is not preferred.

(Repulsion Resistance)

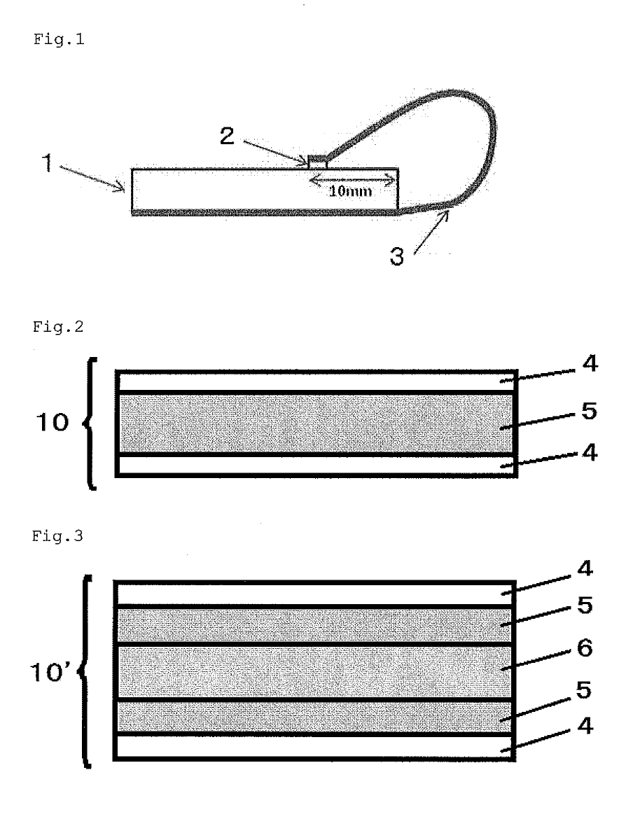

As shown in FIG. 1, a polycarbonate (PC) plate 1 (width: 10 mm, length: 30 mm, thickness: 2 mm), a pressure-sensitive adhesive tape 2 (width: 10 mm, length: 3 mm) obtained by cutting, and a polyethylene terephthalate film (PET film) 3 (Lumirror 100S10 (trade name) manufactured by PANAC Co., Ltd., width: 10 mm, length: 100 mm) were used to from a sample for evaluation. The PC plate and the PET film were bonded together with a pressure-sensitive adhesive.

The sample for evaluation was aged at 23° C. for 24 hours and further aged at 80° C. for 24 hours. Subsequently, the maximum distance between the surface of the polycarbonate plate and the interface between the PET film and the pressure-sensitive adhesive layer was measured with a digital microscope (VH-500 (trade name) manufactured by KEYENCE CORPORATION). The difference between the distances before and after the aging was evaluated as the final “lifting distance” (μm).

The smaller the “lifting distance” is, the better the result of evaluation of the repulsion resistance will be. The lifting distance is preferably 180 μm or less, more preferably 150 μm or less, even more preferably 120 μm or less. If the lifting distance for the repulsion resistance is more than 180 μm, the pressure-sensitive adhesive tape may fail to stably secure an electronic device component or the like for a long period of time, which is not preferred.

TABLE 1

| | | | | | | | Pressure-sensitive | | | Ad- | Holding power | |
|---|---|---|---|---|---|---|---|---|---|---|---|---|
| | Pressure-sensitive adhesive composition | | | | | | adhesive layer | | | hering | (40° C.) | Repulsion |
| Formu- | | | | | Crosslinking | | Bio- | | Support | strength | (length of | resistance |
| lation | Polymer used | | Tackifier | | agent | | mass | Gel | Thick- | to PC | displacement) | (lifting |
| and | | Amount | | Amount | | Amount | degree | fraction | ness | N/20 | mm/ | distance) |
| evaluation | Type | (parts) | Type | (parts) | Type | (parts) | Wt % | Wt % | (μm) | mm | 60 minutes | μm |
| Example 1 | Polyester A | 100 | D125 | 40 | TPA- | 3.5 | 98 | 38.2 | — | 12.0 | 0.15 | 50 |
| | | | | | 100 | | | | | | | |
| Example 2 | Polyester A | 100 | D135 | 40 | TPA- | 4 | 97 | 34.9 | — | 10.5 | 0.25 | 35 |
| | | | | | 100 | | | | | | | |
| Example 3 | Polyester B | 100 | D135 | 80 | TPA- | 7 | 96 | 36.7 | — | 9.9 | 0.24 | 95 |
| | | | | | 100 | | | | | | | |
| Example 4 | Polyester B | 100 | D160 | 80 | TPA- | 7 | 96 | 39.2 | — | 8.3 | 0.22 | 65 |
| | | | | | 100 | | | | | | | |
| Example 5 | Polyester A | 100 | D135 | 40 | TPA- | 4 | 97 | 34.9 | 12 | 10.9 | 0.2 | 50 |
| | | | | | 100 | | | | | | | |
| Example 6 | Natural | 100 | YS Resin | 50 | TACKIROL | 10 | 94 | 35.9 | — | 11.0 | 0.1 | 10 or less |
| | rubber | | PX1150 | | 201 | | | | | | | |
| Example 7 | Natural | 100 | YS Resin | 50 | TACKIROL | 10 | 94 | 35.9 | 12 | 14.1 | 0.1 | 10 or less |
| | rubber | | PX1150 | | 201 | | | | | | | |
| Compar- | Acryl- | 100 | D125 | 30 | CORONATE L | 2 | 19 | 27.5 | 4 | 10.5 | 0.25 | 220 |
| ative | based | | | | | | | | | | | |
| Example 1 | polymer | | | | | | | | | | | |

The evaluation results in Table 1 show that double-sided pressure-sensitive adhesive tapes having a desired level of adhesion, retention, and repulsion resistance are successfully obtained in Examples 1 to 7 and that they are suitable for applications for fixing electronic device components.

On the other hand, the results show that the pressure-sensitive adhesive layer in Comparative Example 1 has a very low biomass degree and that the pressure-sensitive adhesive obtained in Comparative Example 1 is not environmentally compatible or friendly to the global environment. It is also suggested that the low repulsion resistance in Comparative Example 1 may result from the effect of low cohesiveness because an acryl-based polymer used to form an acrylic pressure-sensitive adhesive generally has a molecular weight larger than that of a polyester used to form a polyester-based pressure-sensitive adhesive.

### DESCRIPTION OF REFERENCE SIGNS

1 Polycarbonate (PC) plate
2 Pressure-sensitive adhesive layer
3 Polyethylene terephthalate (PET) film
4 Release liner
5 Pressure-sensitive adhesive layer
6 Support
10 Double-sided pressure-sensitive adhesive tape (with no support)
10′ Double-sided pressure-sensitive adhesive tape (with a support).

1. A double-sided pressure-sensitive adhesive tape for fixing an electronic device component, comprising a pressure-sensitive adhesive layer having a biomass degree of 50% by weight or more.

2. The double-sided pressure-sensitive adhesive tape according to claim 1, which has a holding power of 0.8 mm/60 minutes or less at 40° C.

3. The double-sided pressure-sensitive adhesive tape according to claim 1, which has a lifting distance of 180 μm or less as a measure of repulsion resistance.

4. The double-sided pressure-sensitive adhesive tape according to claim 1, further comprising a release liner provided on at least one side of the pressure-sensitive adhesive layer.

5. The double-sided pressure-sensitive adhesive tape according to claim 1, which has at least two pressure-sensitive adhesive layers and a support provided on at least one side of the pressure-sensitive adhesive layer.
